(19) United States
(12) Patent Application Publication
(10) Pub. No.: US 2021/0076873 A1
(43) Pub. Date: Mar. 18, 2021

(54) Air Fryer with Oil Residual Prevention Arrangement

(71) Applicant: Shenzhen Chenbei Technology Co., Ltd., Shenzhen (CN)

(72) Inventor: Hai WEI, Shenzhen (CN)

(21) Appl. No.: 17/020,785

(22) Filed: Sep. 14, 2020

(30) Foreign Application Priority Data
Sep. 18, 2019 (CN) 201921556548.9

(51) Int. Cl. A47J 37/06; F24H 3/02; A47J 36/38; B01D 46/10; B01D 46/42

(52) U.S. Cl. CPC A47J 37/0641; F24H 3/02; B01D 46/4227; B01D 46/10; A47J 36/38

(57) ABSTRACT

An air fryer includes a first housing, a second housing, a heating element supported in the first housing, a fan supported in the first housing, and an oil residual prevention arrangement. The oil residual prevention arrangement includes a screening member detachably attached on at least one of the first housing and the second housing to provide a boundary between the first housing and the second housing such that oil residual produced from the second housing is substantially blocked by the screen member. The screening member has a plurality of ventilating channels communicating the first housing with the second housing so as to maintain sufficient air circulation between the first housing and the second housing for air frying.

### CROSS REFERENCE TO RELATED APPLICATION

This is a non-provisional application which claims priority to a Chinese patent application having an application number of CN 201921556548.9, and a filing date of Sep. 18, 2019, the entire contents of which is hereby incorporated by reference.

### BACKGROUND

### Field of Invention

Embodiments of the present disclosure relates to an air fryer, and more particularly to an air fryer comprising an oil residual prevention arrangement which is capable of preventing oil residual or dirt from reaching a heating element of the air fryer.

### Description of Related Arts

Air fryers have been widely utilized around the world for heating foods at elevated temperature. Air frying may resemble actual deep frying yet not requiring the use of extensive amount of oil. As a result, air frying has widely been perceived as a healthier alternative than traditional deep-fry cooking.

A conventional air fryer usually comprises a lower housing, an upper housing connected to the lower housing, a heating element and a fan accommodated in the upper housing. Food items may be supported in the lower housing. When the air fryer is operating, the heating element is arranged to heat up the air surrounding it. Heated air is then arranged to be circulated to the lower housing by the fan for heating up the food items.

A major disadvantage of conventional air fryers such as the one described above is that the heating element is positioned right above the compartment where the food items are positioned. As a result, when the air frying takes place, oil residue may, due to vigorous air flow and splashing actions, undesirably reach the upper housing and come into contact with the heating element. This problem will inevitably make cleaning of the heating element very inconvenient. When the heating element is not sufficiently cleaned, the general life span thereof will be shortened.

As a result, there is a need to develop an air fryer which may effectively prevent oil residues from reaching the heating element.

### SUMMARY

Implementations of the present disclosure provide an air fryer comprising an oil residual prevention arrangement which is capable of preventing oil residual or dirt from reaching a heating element of the air fryer.

In one aspect of the present disclosure, it provides an air fryer, comprising:

a first housing;

a second housing connected to the first housing;

at least one heating element supported in the first housing;

a fan supported in the first housing;

an oil residual prevention arrangement, which comprises a screening member detachably attached on at least one of the first housing and the second housing to provide a boundary between the first housing and the second housing such that oil residual produced from the second housing is substantially blocked by the screen member, the screening member having a plurality of ventilating channels communicating the first housing with the second housing so as to maintain sufficient air circulation between the first housing and the second housing for air frying.

This summary presented above is provided merely to introduce certain concepts and not to identify any key or essential features of the claimed subject matter.

### BRIEF DESCRIPTION OF THE DRAWINGS

FIG. 1 is a schematic diagram of an air fryer according to a preferred embodiment of the present invention.

FIG. 2 is a perspective view of a screening member of the air fryer according to the preferred embodiment of the present invention.

FIG. 3 is a partial sectional view of the screen member of the air fryer according to the preferred embodiment of the present invention.

FIG. 4 is a perspective view of the air fryer according to the preferred embodiment of the present invention.

FIG. 5 is a first alternative mode of the air fryer according to the preferred embodiment of the present invention.

FIG. 6 is an enlarged schematic diagram of a screening member of the air fryer according to a first alternative mode of the preferred embodiment of the present invention.

FIG. 7 is another enlarged schematic diagram of the screening member of the air fryer according to the first alternative mode of the preferred embodiment of the present invention.

FIG. 8 is an enlarged schematic diagram of a central portion of the screening member of the air fryer according to the first alternative mode of the preferred embodiment of the present invention.

FIG. 9 is a second alternative mode of the air fryer according to the preferred embodiment of the present invention.

FIG. 10 is a schematic diagram of a main screening frame of a screening member of the air fryer according to the second alternative mode of the preferred embodiment of the present invention.

### DETAILED DESCRIPTION OF THE PREFERRED EMBODIMENT

The following detailed description of the embodiments is the preferred mode of carrying out the present disclosure. The description is not to be taken in any limiting sense. It is presented for the purpose of illustrating the general principles of embodiments of the present disclosure.

It should be appreciated that the terms “install”, “connect”, “couple”, and “mount” in the following description refer to the connecting relationship in the accompanying drawings for easy understanding of embodiments of the present disclosure. For example, the connection can refer to permanent connection or detachable connection. Furthermore, “connected” may also mean direct connection or indirect connection, or connection through other auxiliary components. Therefore, the above terms should not be an actual connection limitation of the elements of embodiments of the present disclosure.

It should be appreciated that the terms “length”, “width”, “top”, “bottom”, “front”, “rear”, “left”, “right”, vertical”, “horizontal”, “upper”, “lower”, “exterior”, and “interior” in the following description refer to the orientation or positioning relationship in the accompanying drawings for easy understanding of embodiments of the present disclosure without limiting the actual location or orientation of embodiments of the present disclosure. Therefore, the above terms should not be an actual location limitation of the elements of embodiments of the present disclosure.

It should be appreciated that the terms “first”, “second”, “one”, “a”, and “an” in the following description refer to “at least one” or “one or more” in the embodiment. In particular, the term “a” in one embodiment may refer to “one” while in another embodiment may refer to “more than one”. Therefore, the above terms should not be an actual numerical limitation of the elements of embodiments of the present disclosure.

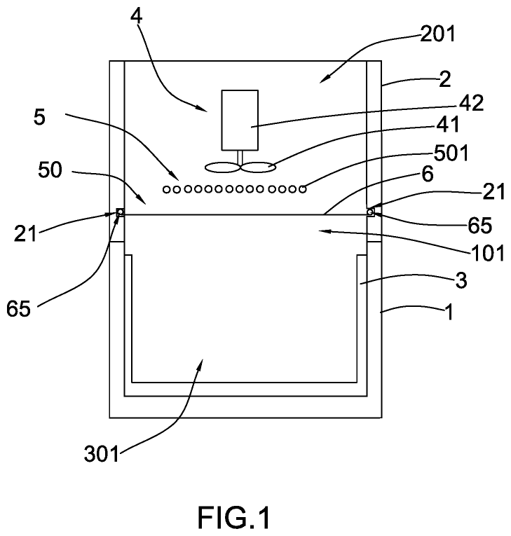

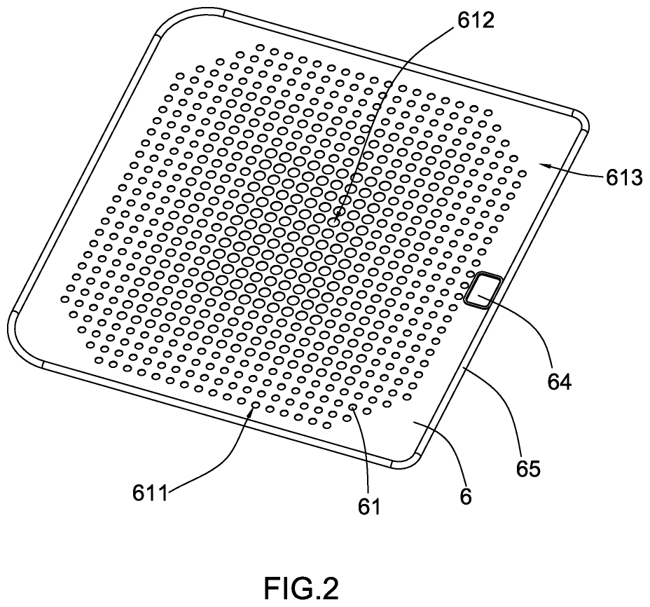

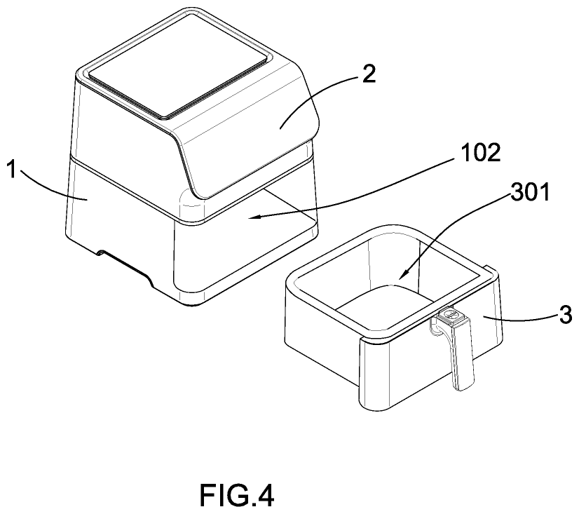

Referring to FIGS. 1 to 4 of the drawings, an air fryer according to a preferred embodiment of the present invention is illustrated. Broadly, the air fryer may comprise a first housing 2, a second housing 1 connected to the first housing 2, at least one heating element 5 supported in the first housing 2, a fan 4 supported in the first housing 2, and an oil residual prevention arrangement 50.

The oil residual prevention arrangement 50 may comprise a screening member 6 detachably attached on at least one of the first housing 2 and the second housing 1 to provide a boundary between the first housing 2 and the second housing 1 such that oil residual produced from the second housing 1 is substantially blocked by the screen member 6. The screening member 6 may have a plurality of ventilating channels 61 communicating the first housing 2 with the second housing 1 so as to maintain sufficient air circulation between the first housing 2 and the second housing 1 for air frying.

According to the preferred embodiment of the present invention, the first housing 2 may have a first housing cavity 201, wherein the heating element 5 and the fan 4 may be supported in the first housing cavity 201. Control electronics may also be supported in the first housing cavity 201 for controlling an operation of the air fryer.

The second housing 1 may have a second housing cavity 101. The air fryer may further comprise a deep-frying tray 3 detachably attached on the second housing 1. The deep-frying tray 3 may have a food storage cavity 301 for temporarily accommodating a predetermined amount of food items. When the deep-frying tray 3 is attached on the second housing 1, the food storage cavity 301 may communicate with the second housing cavity 101, as shown in FIG. 1 of the drawings.

The second housing 1 may have an access opening 102 formed thereon, wherein the deep-frying tray 3 may be arranged to slidably insert through the access opening 102 for detachably attaching the deep-frying tray 3 on the second housing 1 in the manner described above.

In this preferred embodiment, the first housing 2 and the second housing 1 may be integrally connected with each other to form a one-piece structure in which the first housing 2 may be provided on top of the second housing 1. As a slight alternative, however, the first housing 2 and the second housing 1 may be separate structures which are connected with each other in a top-bottom manner.

The fan 4 may be accommodated in the first housing cavity 201. As shown in FIG. 1 of the drawings, the fan 4 may comprise a plurality of fan blades 41 and a driving motor 42 connected to the fan blades 41 and arranged to drive the fan blades 42 to rotate. When the fan blades 41 are driven to rotate, air circulation between the first housing cavity 201 and the second housing cavity 101 is generated.

The heating element 5 may be arranged to generate heat in the first housing cavity 201. The heating element 5 may be supported in a vicinity of the fan blades 41 so that the heat generated by the heating element 5 may be carried away by the air circulation generated by the fan blades 41. In this preferred embodiment, the heating element 5 may comprise at least one heater tube 501 folded to form a manifold structure. The heating element 5 may be supported underneath the fan blades 41 so that when the fan blades 41 are driven to rotate, air circulation may tend to deliver heated air from the first housing cavity 201 downwardly toward the second housing cavity 101 and in particular the food storage cavity 301.

The screening member 6 of the oil residual prevention arrangement 50 may be provided at a position underneath the heating element 5. The screening member 6 may be detachably mounted on the first housing 2. As shown in FIG. 1 of the drawings, the driving motor 42, the fan blades 41, the heating element 5 and the screening member 6 may be sequentially arranged in the first housing 2 in a descending order so as to maximize the effectiveness of the screening member 6. In other words, the screening member 6 may effectively provide a physical barrier between the second housing cavity 101 and the first housing cavity 201 for blocking oil residual from reaching the first housing cavity 201. At the same time, the screening member 6 may also prevent a user's hand from accidentally touching the heating element 5.

The screening member 6 may have a plurality of through ventilating holes 611 for forming the ventilating channels 61 within the ventilating holes 611. The screening member 6 may be configured to have a panel structure and may have a central portion 612 and a peripheral portion 613. The air channels 61 may be formed both on the central portion 612 and the peripheral portion 613 of the screening member 6 in such a manner that more air is allowed to pass through the central portion 612 than that of the peripheral portion 613. Thus, the total air passage area formed on the central portion 612 may be larger than that of the peripheral portion 613. One way to accomplish this may be that a diameter of the ventilating holes 611 forming at the central portion 612 no less than that of the ventilating holes 611 forming at the peripheral portion 613 of the screening member 6. Moreover, a number of the through ventilating holes 611 forming at the central portion 612 may be no less than that of the ventilating holes 611 forming at the peripheral portion 613 of the screening member 6. The purpose of these construction is to ensure that heated air may be directed and concentrated to the food storage cavity 301 of the deep-frying tray 3. As a slight alternative, the ventilating holes 611 may be radially distributed on the screening member 6, and a diameter of each of the ventilating holes 611 may gradually decrease along a radial direction of the screening member 6.

More specifically, the heating element 5 may be provided right above the central portion 612 of the screening member 6 so that the heat generated by the heating element 5 may be effectively delivered to the food storage cavity 301 through the corresponding ventilating channels 61.

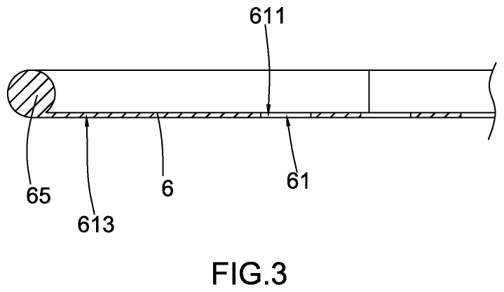

The oil residual prevention arrangement 50 may further comprise a plurality of sliding grooves 21 indently formed on two sidewalls of the first housing cavity 201, wherein two longitudinal side edge portions 65 may be arranged to slidably engage with the sliding grooves 21 so as to slidably mount the screening member 6 on the first housing 2. As shown in FIG. 3 of the drawings, the two longitudinal side edge portions 65 of the screening member 6 may have a substantially circular cross-sectional shape for slidably engaging with the sliding grooves 21 respectively.

The screening member 6 may further comprise a handle 64 formed on the peripheral portion 613 of the screening member 6 for allowing a user to grab thereon to slide the screening member 6 in or out from the first housing cavity 201. The handle 64 may be configured in the form of a protrusion or a slot for allowing a user of the present invention to hold onto it.

The operation of the present invention is as follows: a user may put food items in the deep-frying tray 3 and attach the deep-frying tray 3 in the second housing 1. After that, the user may turn on the air fryer and heat may be generated by the heating element 5. At the same time, the fan blades 41 may be driven to rotate by the driving motor 42. The heat generated by the heating element 5 may be circulated by the rotating fan blades 41 and eventually reach the food storage cavity 301 through the ventilating channels 61. On the other hand, oil residuals or other dirt materials emanating from frying the food items may be substantially blocked by the screening member 6 so as to prevent them from reaching the heating element 5. After deep frying, the screening member 6 may be slidably detached from the first housing 2 for further cleaning.

The advantages of the present invention is that by installing the screening member 6 between the first housing 2 and the second housing 1, oil residuals or other dirt materials emanating from frying food items may be substantially blocked by the screening member 6 while the air channels 61 may still provide sufficient air circulation between the heating element 5 and the food storage cavity 301.

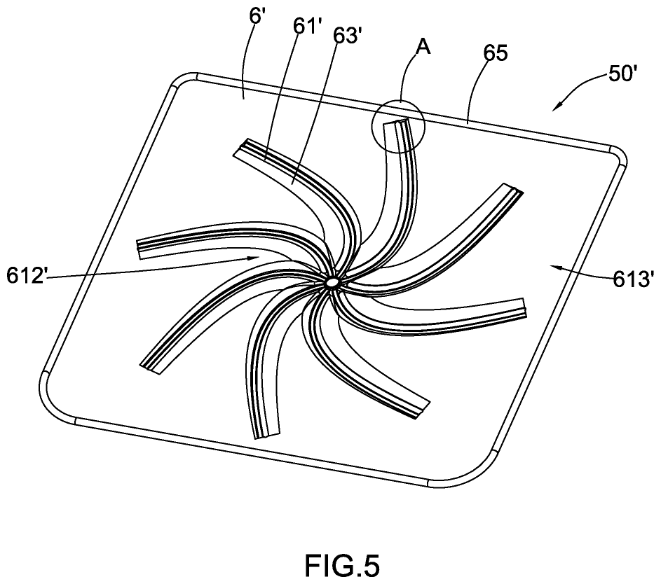

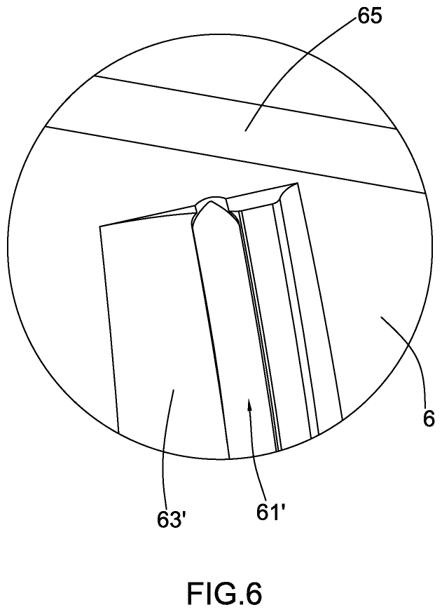

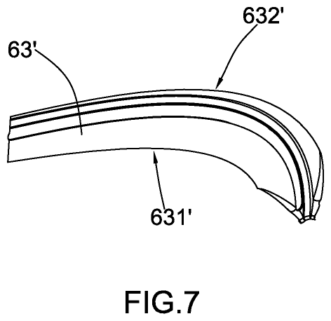

Referring to FIG. 5 to FIG. 8 of the drawings, a first alternative mode of the air fryer according to the preferred embodiment of the present invention is illustrated. The first alternative mode is similar to the preferred embodiment, except the screening member 6′ of the oil residual prevention arrangement 50′. According to the first alternative mode, the screening member 6′ may also be configured to have a panel structure and may have a central portion 612′ and a peripheral portion 613′. The air channels 61′ may be formed both on the central portion 612′ and the peripheral portion 613′ of the screening member 6′ in such a manner that more air is allowed to pass through the central portion 612′ than that of the peripheral portion 613′. Thus, the total air passage area formed on the central portion 612′ may be larger than that of the peripheral portion 613′.

Specifically, in this first alternative mode, the screening member 6′ may have a plurality of through ventilating slots 62′ forming the ventilating channels 61′. The ventilating slot 62′ may extend outwardly and radially from a central portion 615′ of the screening member 6′, wherein each of the ventilating slots 62′ may have two curved edges 621′ for forming a blade-like cross sectional shape of the ventilating slot 62′.

Note that in this first alternative mode, the screening member 6′ may further comprise a plurality of guiding members 63′ provided in the ventilating slots 62′ respectively for guiding air flow between the first housing 2 and the second housing 1′. Each of the guiding members 63′ may have a concavely curved surface 631′ facing the heating element 5, and a convexly curved surface 632′ facing the deep-frying tray 3. The guiding member 63′ is provided in the corresponding ventilating slot 62′ so as to guide the flow of air pass through the ventilating slot 62′. The overall contour of the ventilating slots 62′ and the guiding member 63′ may guide air circulated from the fan blades 41 to flow toward the deep-frying tray 3. Thus, the overall contour of the ventilating slots 62′ and the guiding member 63′ may form curved ventilating channels 61′. Moreover, the concavely curved shape of the concavely curved surface 631′ may also help to better collect residual oil from the deep-frying tray 3 and allow the residual oil to drip back to the deep-frying cavity 301.

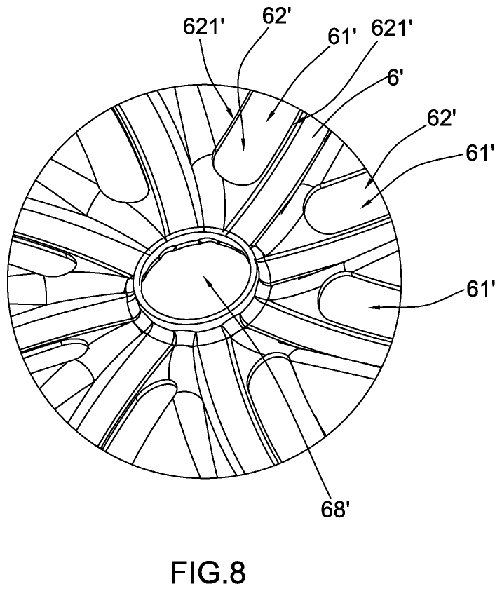

Referring to FIG. 8 of the drawings, the screening member 6′ may further have a central hole 68′ formed at a center of the screening member 6′, wherein the ventilating slots 62′ may outwardly and radially extend from the central hole 68′. One ventilating channel 61′ may also be formed in the space surrounded by the central hole 68′. The provision of the central hole 68′ allows direct vertical delivery of air from the fan blades 41 toward the deep-frying cavity 301.

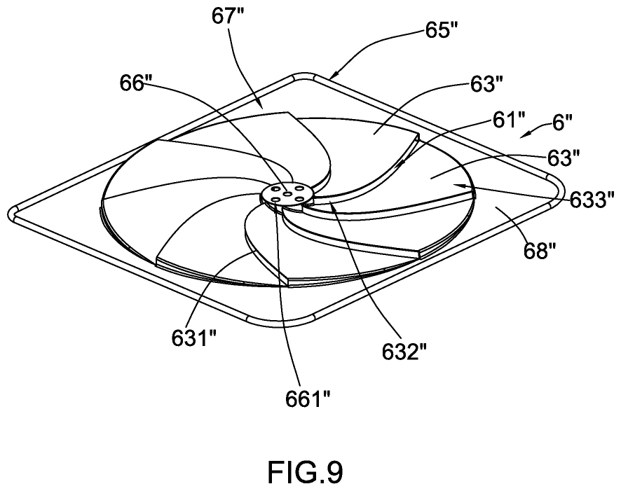

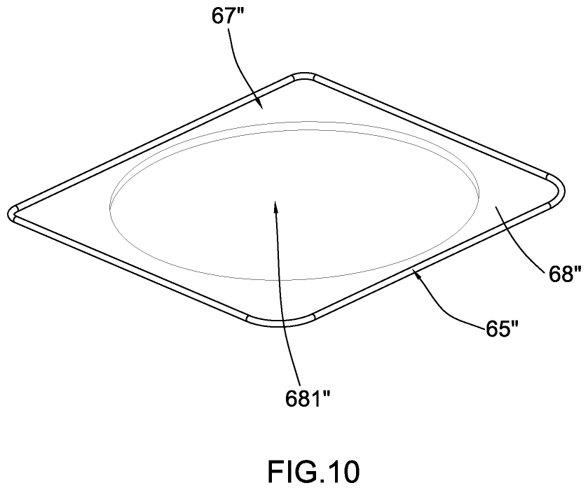

Referring to FIG. 9 and FIG. 10 of the drawings, a second alternative mode of the air fryer according to the preferred embodiment of the present invention is illustrated. The second alternative mode is similar to the preferred embodiment, except the screening member 6″ of the oil residual prevention arrangement 50″.

According to the second alternative mode, the screening member 6″ may comprise a main screening frame 68″ having a peripheral boundary rim 65″, a through central cavity 681″, and an extension portion 67″ extended between the peripheral boundary rim 65″ and the through central cavity 681″. Moreover, the screening member 6″ may further comprise a connecting member 66″ supported at the through central cavity 681″, and a plurality of guiding blades 63″ radially extended between the connecting member 66″ and the extension portion 67″ to form the ventilating channels 61″ as a space between each two adjacent guiding blades 63″.

Each of the guiding blades 63″ has an inner end portion 632″ connected to the connecting member 66″, and an outer end portion 633″ connected to the extension portion 67″ of the main screening frame 68″. Each of the guiding blades 63″ may have a curved cross-sectional shape when viewed from the side, and resemble a fan blade contour when viewed from the top. Each of the guiding blades 63″ may further have two guiding edges 631″ extended between the inner end portion 632″ and the outer end portion 633″. The two guiding edges 631″ of two adjacent guiding blades 63″ facing each other may have different vertical height so as to form the corresponding ventilating channel 61″ between each two adjacent guiding blades 63″. Each of the guiding edges 631″ may be curved in such a manner that a radius curvature of the guiding edge 631″ may gradually decrease from the inner end portion 632″ toward the outer end portion 633″ of the corresponding guiding blade 63″, so that a surface area of each of the guiding blades 63″ may gradually increase from the inner end portion 632″ toward the outer end portion 633″.

The provision of the guiding blades 63″ having the above-mentioned contour may allow air flowing from the first housing 2 to the second housing 1 to form a predetermined degree of vortex flow so as to allow more air to flow toward the deep-frying tray 3, better air circulation between the first housing 2 and the second housing 1, and to facilitate more effective air frying of the food items. The guiding blades 63″ may also help to block and collect oil residuals splashing from the deep-frying cavity 301. The oil residuals thus blocked and collected may eventually drip back down to the deep-frying cavity 301. The guiding blades 63″, the extension portion 67″ and the connecting member 66″ may be integrally connected to form a one-piece structure. This may facilitate easy manufacturing and cleaning of the screen member 6″.

Moreover, the connecting member 66″ may further have a plurality of through holes 661″ for allowing heated air to be directly delivered to a central portion of the second housing 1 so as to enhance air frying performance of the air fryer.

The screening members as described in the above preferred embodiment and its alternatives may be configured from durable and heat resistant material, such as metallic material, composite material or heat resistant plastic material.

Embodiments of the present disclosure, while illustrated and described in terms of disclosed embodiments and several alternatives, is not limited to the particular description contained in this specification. Additional alternative or equivalent components could also be used to practice embodiments of the present disclosure.

What is claimed is:

1. An air fryer, comprising:
a first housing;
a second housing connected to said first housing;
at least one heating element supported in said first housing;
a fan supported in said first housing;
an oil residual prevention arrangement, which comprises a screening member detachably attached on at least one of said first housing and said second housing to provide a boundary between said first housing and said second housing such that oil residual produced from said second housing is substantially blocked by said screen member, said screening member having a plurality of ventilating channels communicating said first housing with said second housing so as to maintain sufficient air circulation between said first housing and said second housing for air frying.

2. The air fryer, as recited in claim 1, wherein said first housing has a first housing cavity, wherein said heating element and said fan are supported in said first housing cavity, said second housing having a second housing cavity, said air fryer further comprising a deep-frying tray detachably attached on said second housing, said deep-frying tray having a food storage cavity for temporarily accommodating a predetermined amount of food items.

3. The air fryer, as recited in claim 2, wherein said fan comprises a plurality of fan blades and a driving motor connected to said fan blades and arranged to drive said fan blades to rotate for generating air circulation between said first housing cavity and said second housing cavity.

4. The air fryer, as recited in claim 3, wherein said heating element is supported underneath said fan blades so that when said fan blades are driven to rotate, air circulation is arranged to deliver heated air from said first housing cavity downwardly toward said second housing cavity and said food storage cavity.

5. The air fryer, as recited in claim 4, wherein said screening member of said oil residual prevention arrangement is provided at a position underneath said heating element, said screening member being detachably mounted on said first housing.

6. The air fryer, as recited in claim 5, wherein said screening member has a plurality of through ventilating holes for forming said ventilating channels within said ventilating holes respectively.

7. The air fryer, as recited in claim 6, wherein said screening member is configured to have a panel structure and has a central portion and a peripheral portion, said ventilating channels being formed on said central portion and said peripheral portion of said screening member in such a manner that more air is allowed to pass through said central portion than that of said peripheral portion.

8. The air fryer, as recited in claim 7, wherein said heating element is provided right above said central portion of said screening member so that said heat generated by said heating element is effectively delivered to said food storage cavity through said corresponding ventilating channels.

9. The air fryer, as recited in claim 8, wherein said oil residual prevention arrangement further comprises a plurality of sliding grooves indently formed on two sidewalls of said first housing cavity, wherein two longitudinal side edge portions of said screening member are arranged to slidably engage with said sliding grooves respectively so as to slidably mount said screening member on said first housing.

10. The air fryer, as recited in claim 9, wherein said screening member further comprises a handle formed on said peripheral portion of said screening member for allowing a user to grab thereon to slide said screening member in and out from said first housing cavity.

11. The air fryer, as recited in claim 5, wherein said screening member has a plurality of through ventilating slots forming said ventilating channels, said ventilating slot extending outwardly and radially from a central portion of said screening member, wherein each of said ventilating slots having two curved edges for forming a blade-like cross sectional shape of said ventilating slot.

12. The air fryer, as recited in claim 11, wherein said screening member further comprises a plurality of guiding members provided in said ventilating slots respectively for guiding air flow between said first housing and said second housing, each of said guiding members having a concavely curved surface facing said heating element, and a convexly curved surface facing said second housing.

13. The air fryer, as recited in claim 12, wherein said screening member further has a central hole formed at said central portion of said screening member, wherein said ventilating slots outwardly and radially extending from said central hole, one of said ventilating channels being formed in a space surrounded by said central hole.

14. The air fryer, as recited in claim 13, wherein said heating element is provided right above said central portion of said screening member so that said heat generated by said heating element is effectively delivered to said food storage cavity through said corresponding ventilating channels.

15. The air fryer, as recited in claim 5, wherein said screening member comprises a main screening frame having a peripheral boundary rim, a through central cavity, and an extension portion extended between said peripheral boundary rim and said through central cavity, said screening member further comprising a connecting member supported at said through central cavity, and a plurality of guiding blades radially extended between said connecting member and said extension portion to form said ventilating channels as a spaces between each two adjacent guiding blades.

16. The air fryer, as recited in claim 15, wherein each of said guiding blades has an inner end portion connected to said connecting member, and an outer end portion connected to said extension portion of said main screening frame, each of said guiding blades further having two guiding edges extended between said inner end portion and said outer end portion, said two guiding edges of said two adjacent guiding blades facing each other having different vertical height so as to form said corresponding ventilating channel between each said two adjacent guiding blades.

17. The air fryer, as recited in claim 16, wherein each of said guiding edges being configured to be curved in such a manner that a radius curvature of said guiding edge gradually decreases from said inner end portion toward said outer end portion of said corresponding guiding blade, so that a surface area of each of said guiding blades gradually increases from said inner end portion toward said outer end portion.

18. The air fryer, as recited in claim 17, wherein said connecting member further has a plurality of through holes for allowing heated air to be directly delivered to a central portion of said second housing.
